(19) United States
(12) Patent Application Publication
(10) Pub. No.: US 2012/0166262 A1
(43) Pub. Date: Jun. 28, 2012

(54) ENGAGEMENT AND PAYMENT PROCESSING PLATFORM

(75) Inventors: Todd A. Rooke, Waconia, MN (US); Joseph Rogness, JR., Eden Prairie, MN (US)

(73) Assignee: JINGIT, LLC, Edina, MN (US)

(21) Appl. No.: 13/306,947

(22) Filed: Nov. 29, 2011

Related U.S. Application Data
(60) Provisional application No. 61/417,725, filed on Nov. 29, 2010.

(51) Int. Cl. G06Q 30/02; G06Q 99/00

(52) U.S. Cl. 705/14.16; 705/1.1; 705/14.48

(57) ABSTRACT

An engagement and payment processing platform is disclosed. Within the platform, entities and processes interact with an engagement management system to manage transactions, compensation events, consumer profiles, etc.

### CROSS-REFERENCE TO RELATED APPLICATION

This application claims priority under 35 U.S.C. §119(e) to U.S. Provisional Patent Application Ser. No. 61/417,725 filed on Nov. 29, 2010, and incorporated herein by reference.

### BACKGROUND

Since the advent of the internet, brands continue to find ways to engage consumers to advertise and promote products, services and offers while gathering information from consumers to ultimately drive them to a purchase. With increasing sophistication, brands strive to reach consumers in new ways with engagements in order to achieve the greatest benefit from their marketing and advertising programs. However, to date, it has been difficult for brands to both reach and engage their intended audience efficiently.

In some instances, consumers can be compensated for performing various actions. For example, a consumer may be presented with a coupon that can be printed and physically brought to a store for redemption of a discount on products and/or services. In other instances, consumers can be compensated for watching a video. One example implementation is disclosed in U.S. Patent Application Publication Number 2010/0100440, the contents of which are hereby incorporated by reference in their entirety. While the internet is useful for efficiently delivering content such as coupons and videos, often times content that is delivered to the consumer is not relevant and impact from the content delivery is not effectively analyzed to maximize efficiency in engaging consumers. Simply paying a consumer for their attention to watch an advertisement does not satisfy the marketers' objective. Instead, advertisers are interested in legitimate engagement with the consumer that leads to action and/or transactions online or at a retail location.

### SUMMARY

An engagement and payment processing platform is disclosed. Within the platform, several entities and processes can interact with an engagement management system. For example, a sponsor can initiate a campaign to target a particular group of consumers. Each consumer includes a profile defining a persona and an activity score. The persona includes information associated with the consumer and can include demographic and psychographic attributes, while the activity score is indicative of several factors based on activities associated with the consumer. After a consumer connects with the engagement management system, the profile of the consumer can be accessed to identify a campaign that matches the consumer. The consumer can participate in a compensation event associated with the campaign, as well as receive an offer and/or complete a transaction through the engagement management system.

### BRIEF DESCRIPTION OF THE DRAWINGS

FIG. 1 is a block diagram of an engagement and payment processing platform.

FIG. 2A is a flow diagram of a method for generating and updating a consumer profile.

FIG. 2B is a block diagram of a consumer profile.

FIG. 3 is a flow diagram of a method of facilitating a sponsor campaign.

FIG. 4A is a flow diagram of a method of engaging a consumer.

FIG. 4B is a diagram of a campaign matching filter for selecting relevant engagement elements.

FIG. 4C is a block diagram of components displayed during an engagement with a consumer.

FIG. 5 is a block diagram of components displayed for creating a compensation event.

FIG. 6 illustrates screen shots of engagement elements that can be displayed during a compensation event.

FIG. 7 is a flow diagram of steps in a method for compensating a consumer on a mobile device.

FIG. 8 is a flow diagram of steps in a method for transferring funds to a debit card on a mobile device.

FIG. 9 is a flow diagram of a method of compensating a consumer who influences behavior and purchases.

### DETAILED DESCRIPTION

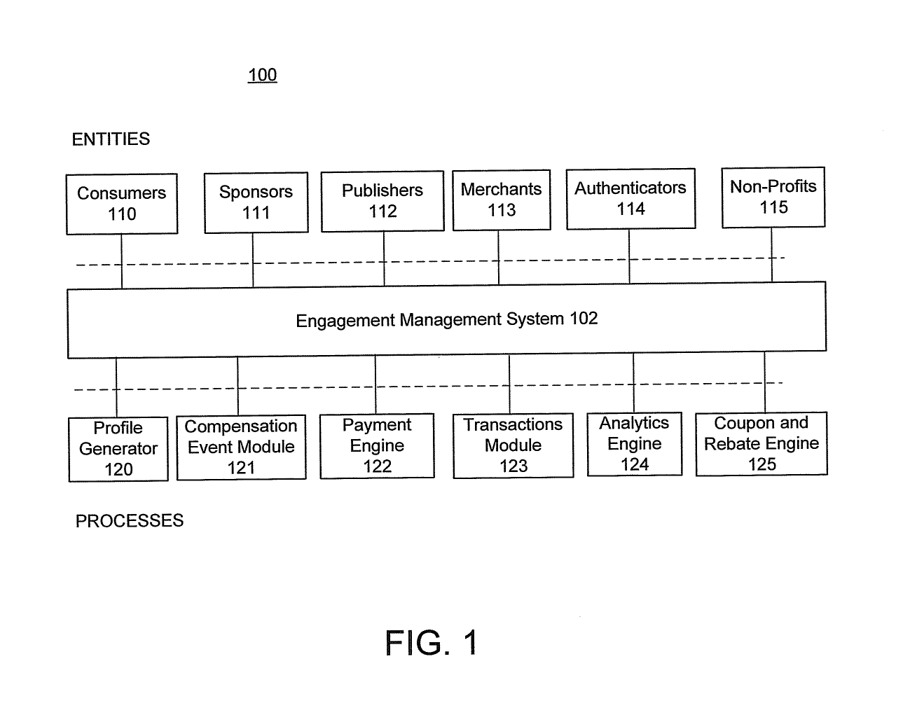

FIG. 1 is a block diagram of an engagement and payment processing platform 100, including an engagement management system 102 as well as selected entities 110-115 and processes 120-125 that interact with the engagement management system 102. Engagement management system 102 is configured to be embodied on a suitable computing system so as to interact with the entities 110-115 and processes 120-125 in order to perform various functions. These functions include, but are not limited to: (1) maintaining and updating consumer profiles, (2) matching campaign compensation events with a desired target group of consumers, (3) compensating consumers based on engagement with system 102, (4) delivering relevant offers to consumers and monitoring offer related transactions specific to the consumer, (5) compensating multiple parties in a transaction, (6) monitoring and adjusting a persona and activity score for consumers and (7) providing a bridge between an online advertising campaign distribution and a physical location selling goods.

Details on the entities 110-115 and processes 120-125 are provided below. In general terms, as illustrated in FIG. 1, the entities 110-115 include consumers 110, sponsors 111, publishers 112, merchants 113, authenticators 114, and non-profits 115. As used herein, an “entity” can refer to information associated with an individual or organization that is used during interaction with the engagement management system 102, the entities themselves (e.g., an individual consumer) and/or one or more computing devices operated by an entity. Processes 120 to 124 include a profile generator 120, a compensation event module 121, a payment engine 122, a transaction module 123, an analytics engine 124 and a coupon and rebate engine 125. As used herein, a “process” refers to a module or the like that processes information associated with one or more of the entities 110-115 based on interaction between one or more of the entities 110-115 and the engagement management system 102.

It is worth noting that access to the engagement management system 102 by an entity 110-115 can be facilitated through a suitable computing device such as a personal computer, tablet, smart phone, game console, DVD Player, set top box, television, ATM or the like, which communicates with the system 102 through a suitable communication network such as the internet. Engagement management system 102 can be implemented on a computing system such as a server accessible through the internet and equipped to implement each of the processes 120-125 as well as access information associated with the entities 110-115.

Consumers 110 are individuals targeted for advertising and/or input of information based on interaction with the engagement management system 102. Associated with the consumers 110 is varying information about each consumer, including demographic information (e.g., age, sex, and location), psychographic information (e.g., interests, activities, opinions) currency based balances, currency based account information (e.g., a bank account), notification information (e.g., email address, cell phone number), social and/or networking account information (e.g., Facebook, Twitter, LinkedIn), authorization preferences, privacy preferences, etc. In particular, each consumer is associated with a profile, including both a persona and an activity score, as discussed below.

Sponsors 111 are associated with an organization focused on advertising and/or gathering information related to a particular brand, product or service, such as a retailer, advertising agency, research organization, non-profit organization, governmental entity, etc. A sponsor 111 can initiate a campaign to either advertise a particular brand, product, service, etc. and/or collect information from consumers about a particular brand, product, etc. In one embodiment, the sponsor can indicate a target group based on persona and/or activity score of a consumer profile. Moreover, a consumer may have brand specific attributes that can indicate a match for a particular campaign. As such, engagement of the campaign with consumers can be a selected group. The campaign can include a particular budget that is monitored and distributed by the engagement management system 102.

Publishers 112 provide a point of contact between a consumer 110 and the engagement management system 102, such as a web content provider. In one embodiment, if a publisher 112 displays an engagement that ultimately leads to a transaction with a consumer 110, the publisher 112 can receive compensation, for example a percentage of the transaction. In another embodiment, publisher 112 can receive compensation for recruiting sponsors 111 and facilitating the initiation of a campaign as compensation events 121 are completed. In another embodiment, publisher 112 may also be a merchant 113 selling goods or services through the engagement management system 102.

Merchants 113 are associated with an organization that sells products and/or services. For example, a merchant may sell digital songs, digital software files, physical goods, household services, etc. In one example, the merchant 113 can form a point of contact with the consumer. Moreover, the merchant 113 can be one and the same as the sponsor 111, or independent therefrom. In one embodiment, merchant 113 can present an offer to a consumer 110, which can include a coupon.

Authenticators 114 are third-party organizations that include information about one or more of the consumers 110 so as to provide independent verification of the consumers 110. Example authenticators can include social and or networking platforms (e.g., Facebook, MySpace, Twitter, LinkedIn), OpenID and or oAuth providers (e.g., Gmail, Yahoo!, AOL), companies that do business with consumers (e.g., a cell phone company), etc. Authenticators 114 can be utilized by the engagement management system 102 to assist in verifying attributes of consumers 110, which can directly change an activity score for a consumer. For example, the system 102 may send a code via text message to a cell phone of a consumer. If the consumer then delivers this code to the system 102, it can indicate that the consumer is dependable and reachable. Thus the activity score associated with the consumer can be adjusted accordingly.

Non-Profits 115 are companies organized as non-profit tax entities under a suitable tax designation similar to that found in United States Code 26, Section 501(c)(3). Any entity within the engagement management system can direct any of their respective portions of any compensation event, offer, or transaction to a non-profit. Moreover, the non-profit 115 can be one and the same as the sponsor 111, publisher 112, merchants 113, authenticators 114, or independent therefrom. In one embodiment, all participants associated with a compensation event 121 can contribute their portion of compensation to the non-profit 115.

Entities 110-115 discussed above are not intended to be limiting. Other entities can further be used that include information and interact with engagement management system 102 in various ways. For example, affiliates can be entities and persons or companies that facilitate an engagement or payment through a system, process, license or other means. In one embodiment, a flat fee may be directed to the affiliate in the compensation event, in another embodiment a percentage based and volume/value based compensation models are utilized.

Profile generator 120 generates a profile for each consumer 110 that is associated with the engagement management system 102. In one embodiment, the profile includes a persona having demographical and psychographical information associated with the consumer as well as an activity score generated as a function of information about the consumer and indicative of a likelihood that information about the consumer is authentic. For example, factors that can adjust an activity score include a validated phone number, a validated bank account number, consistency of the consumer in answering questions, activity of the consumer, independent validation of information (e.g. Tax ID #, birthdate, and address with a credit reporting agency), compliance of consumer within terms and conditions, etc. Additionally, as discussed above, authenticators 114 can be used in adjusting the activity score. Ultimately, the activity score can be used to generate a relevancy score based on a particular campaign initiated by a sponsor 111.

Compensation events 121 are events with direct interaction between the consumer 110 and the engagement management system 102. In turn, the consumer 110 is compensated for participating in the interaction. Example events can include a video advertisement, a survey, interactive media, a game, etc. In operation, a consumer 110 will participate in a compensation event and further be compensated after completing participation in the event. For example, a consumer 110 can be compensated after viewing a video related to a product and completing a questionnaire related to the product. The compensation can include monetary compensation in one or more currencies (e.g., $0.05, 0.10, etc.) and optionally one or more offers related to purchasing a product or service.

Payment engine 122 processes payments in real time to one or more associated entities 110-115 within the engagement management system 102. For example, the payment engine 122 can compensate a consumer 110 after a compensation event 121. Moreover, if a consumer completes a transaction based on a compensation event 121, payment engine 122 can distribute payment to merchant 113 and, if appropriate, to a publisher 112. The payment engine 122 also acts as a gateway facilitating the transferring of currency on or off of the engagement management system 102. For example, a consumer may transfer currency from their profile to a financial institution's savings or checking account or the engagement management system's 102 issued branded or non-branded open loop or closed loop card. This list is not intended to be an inclusive list of source or destinations that the payment engine can exchange currency with.

Transaction module 123 implements transactions between entities consumer 110, sponsor 111, publisher 112, merchant 113, authenticators 114 and non-profits 115. For example, the consumer 110 may initiate a purchase from merchant 113, in which the transaction module 123 would utilize the payment engine 122 to send payment to the merchant 113 and send the purchased item to the consumer 110. The transaction module 123 can also compensate other entities concurrently at the time of the transaction settlement associated with the transaction according to an agreement through use of payment engine 122. For example, a publisher 112 that initiated the engagement with the consumer 110 can receive compensation.

Analytics engine 124 can monitor consumer activity with the engagement management system 102 and provide an indication of effectiveness for a particular sponsor campaign or an event that prompted a transaction to take place. In this manner, transaction module 123 can provide information to analytics engine 124. Purchase history through engagement management system 102 or associated closed and or open loop cards will be processed by analytics engine 124 in connection with profile generator 120 to make profile modifications, for example by modifying psychographic attributes and/or activity score components.

Coupon and Rebate Engine 125 in connection with the compensation event module 121, can create, manage, and fulfill coupons and rebates with thresholds on budget, timeframe, and target group. Additionally, the coupon and rebate engine 125 can capture and relate information associated with consumer purchase and purchase details at merchants 113 with the compensation events 121. In addition to issuing and fulfilling coupons and rebates, the engine 125 can monitor and optionally fulfill third party coupons or rebates. This engine 125 can integrate with entities for purchase information (e.g., a merchant 113), which could issue a unique code, barcode, or QR code on the bottom of a receipt that could be entered or scanned by a consumer whereby the coupon and rebate engine would connect to merchant to get online or retail purchase information. For example, purchase detail through engagement management system issued or associated cards as described above can be used for purchase information to match against compensation events 121.

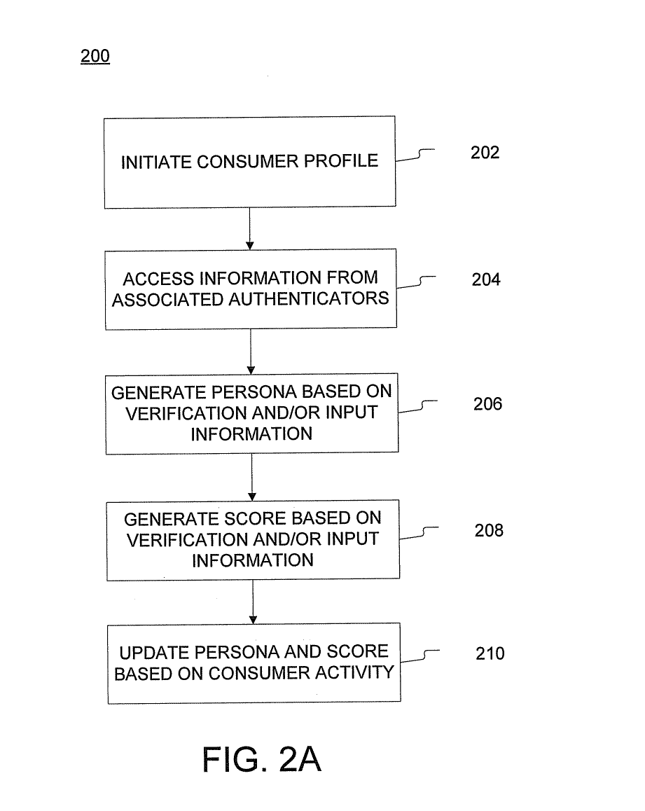

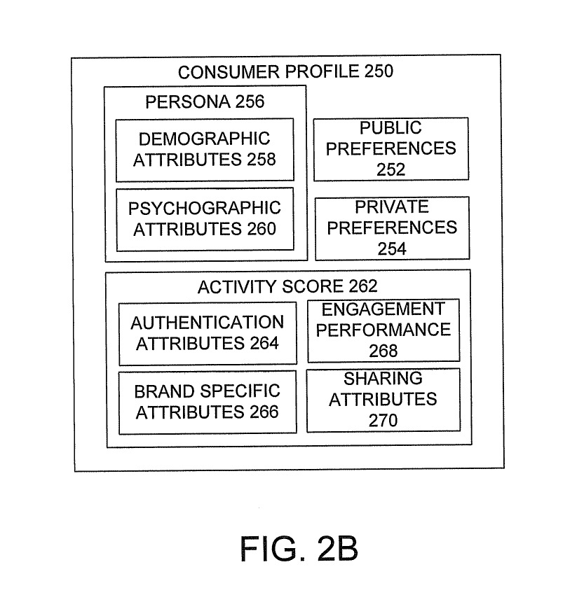

FIG. 2A is a flow diagram of a method 200 for generating and updating a profile for a consumer 110. Additionally, a block diagram of an exemplary profile 250 is illustrated in FIG. 2B. At step 202, a consumer profile 250 is initiated. The profile 250 can be initiated by a consumer in a variety of different ways and includes information associated with the consumer. For example, the profile 250 can be initiated based on a pre-existing relationship between a consumer 110 and one or more of the authenticators 114 that has an existing relationship with the engagement management system 102. Alternatively, or in addition to, the consumer 110 can initiate the profile 250 by entering information to be directly accessed by the engagement management system 102. In any event, information is stored and associated with the consumer 110 in the consumer profile 250. The consumer 110 can also initiate public preferences 252 and private preferences 254 that indicate what information within the profile 250 is public (i.e., accessible by those other than engagement management system 102) and what information within the profile is private (i.e., inaccessible to those outside of the engagement management system 102).

At step 204, information is accessed from associated authenticators. For example, the consumer may have a previously created account with an authenticator such as Facebook, Yahoo, AOL, LinkedIn, etc. At step 206, a persona 256 is generated based on input and/or derived information from the consumer 110 and authenticators 114. The persona includes demographic attributes 258 and psychographic attributes 260. Demographic attributes 258 relate to demographical information associated with the consumer such as age, sex, income, zip code, etc. Psychographic attributes 260 indicate lifestyle choices of the consumer such as what the consumer 110 wants, what the consumer 110 has, what the consumer 110 likes and what the consumer 110 doesn't like. Moreover, the psychographic attributes can relate to interests, activities and opinions of a consumer. The demographic attributes 258 and psychographic attributes 260 provide information about a consumer that can be targeted by a sponsor 111.

At step 208, an activity score 262 is generated based on authenticity and behavior of the consumer 110. The activity score 262 is based on several factors, including authentication attributes 264, brand specific attributes 266, engagement performance 268 and sharing attributes 270. The authentication attributes 264 relate to authenticity of information about the consumer 110. Brand specific attributes 264 relate to a likelihood that a consumer 110 will engage and/or purchase a particular brand. Engagement performance 268 relates to activities that the consumer 110 has performed with engagement management system 102. For example, a consumer 110 who is willing to participate in an offer or survey can have the activity performance adjusted based on this activity. Sharing attributes 270 relate to how a consumer shares and/or influences other consumers associated with the engagement management system 102. At step 210, the persona 256 and score 262 can continually be updated based on consumer activity and/or entry of information within the profile 250.

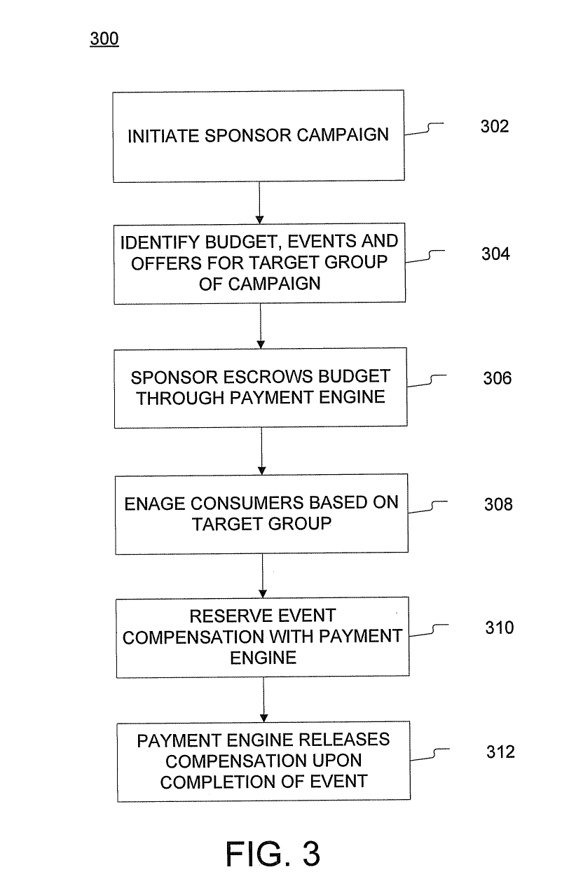

FIG. 3 is a flow diagram of a method 300 for facilitating a compensation event. At step 302, a sponsor campaign is initiated. Next, at step 304, a budget, co-sponsors, compensation sharing, compensation events and offers for a target group of the campaign are identified. At step 306, the sponsor escrows the budget through the payment engine. Next, at step 308, consumers are engaged based on a target group for the sponsor campaign. Upon beginning a compensation event, compensation is reserved against escrow budget at step 306 within the payment engine at step 310. If escrow budget at step 306 is insufficient, the compensation event will not be reserved or presented to consumer. If a consumer fails to complete the compensation event, the compensation and the payment engine is released back into the escrow. Upon completion of the compensation event, the payment engine releases payment to the consumer and any and all additional participating entities at step 312.

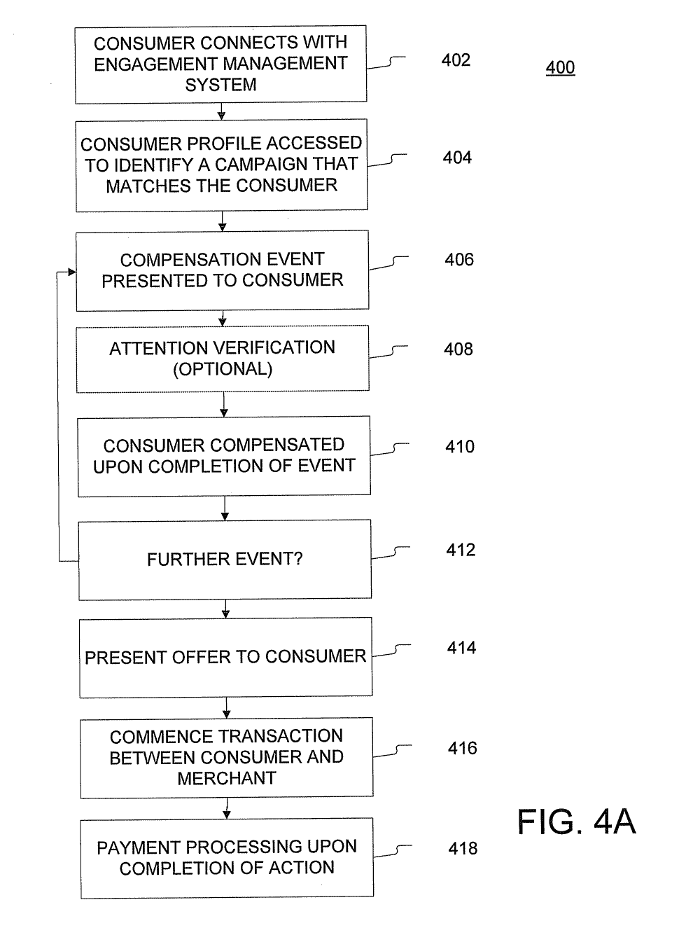

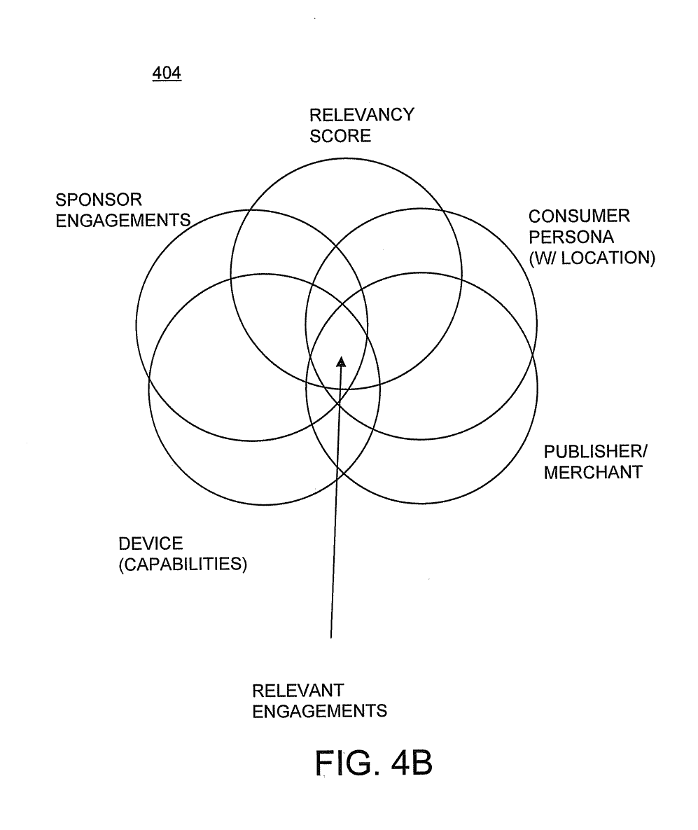

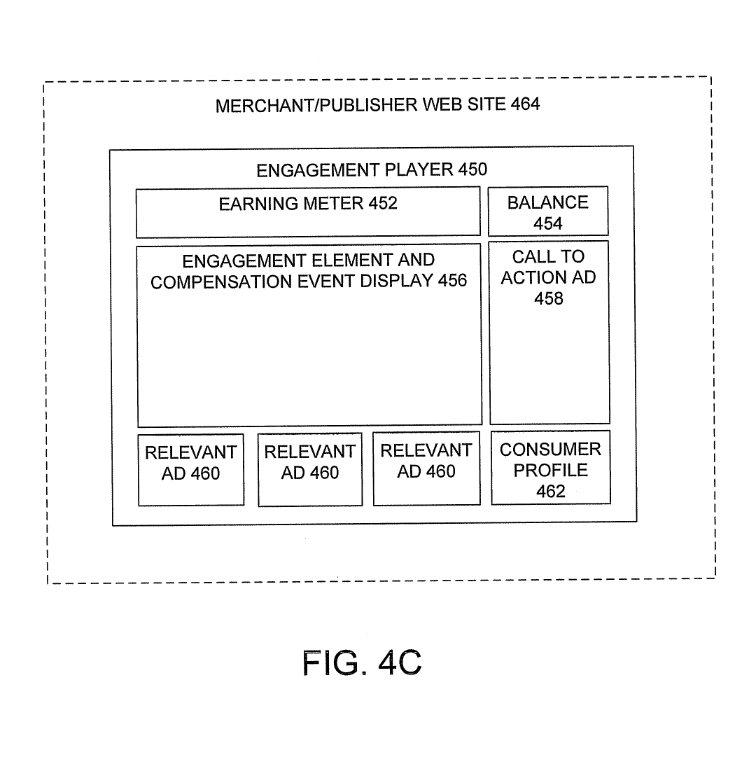

FIG. 4A is a flow diagram of a method 400 of an engagement between a consumer 110 and the engagement management system 102. At step 402, the consumer connects with the engagement management system. For example, the consumer may directly connect with a merchant, a publisher, or other entity through a personal computer, mobile phone, or the like. At step 404, the consumer profile is accessed to identify a campaign that matches the consumer. For example, the persona of the consumer can be accessed in order to find a campaign that matches the consumer's persona, a relevancy score can be calculated, a sponsor's engagements can be accessed, the capabilities of the device the consumer is accessing the system from and a publisher or merchant identifier can further filter the compensation events made available to the consumer. Such a filter is illustrated in FIG. 4B, in which step 404 identifies relevant engagements for presentation to the consumer based on these factors.

In one embodiment, the value the sponsor specifies for the campaigns targeting criteria can be uniquely different for each collection of targeting criteria. In a further embodiment, campaign matching algorithm can calculate a relevancy score for a consumer based on the person and/or the activity score of the consumer. Factors used in calculating the relevancy score can be chosen by a sponsor 111 and/or selected to determine a relevant group of users.

Next, at step 406, a compensation event from the campaign is presented to the consumer. For example, as discussed above, the compensation event can include watching a video and/or completing a survey related to a particular product. An optional attention verification and/or anti-robot step 408 can be presented to the consumer in order to insure the consumer is participating in the compensation event. After the compensation event is completed, the consumer is compensated at step 410.

FIG. 4C is a block diagram of an exemplary user interface, also referred to as an engagement player 450, presented to a consumer during a compensation event. The player 450 can include an earning meter 452 showing how much a consumer can earn during a particular period (e.g., a week, month) and a balance 454 showing how much a consumer has earned. The interface further includes a compensation event display 456, a call to action advertisement 458 and one or more relevant ads 460. Additionally, information 462 related to the consumer profile can be displayed. The compensation display 456 is associated with a campaign and directly relates to earnings for the consumer. The call to action advertisement 458 can be associated with the event display 456 or independent therefrom. The call to action advertisement 458 can provide a hyperlink that presents the consumer with a suitable action to perform. Relevant ads 460 can display advertisements that may be of interest to the consumer based on the profile 250 of the user and any campaign conducted by the engagement management system 102. In a further embodiment, the player 450 can be embedded within a website 464 such as a merchant or publisher.

Returning to FIG. 4A, at step 412, method 400 determines whether a further event will be processed. If a user wishes to initiate any type of purchase, a plurality of compensation events may be needed to complete that purchase. In one embodiment, after the events are completed, an offer is presented to the consumer at step 414. For example, the offer can be a coupon or discount used by the consumer to purchase a particular product, or a linked compensation event for completing the offer. If the consumer wishes to purchase the product, a transaction between a consumer and merchant can be commenced. For example, if a consumer has received enough compensation to purchase a song, the consumer can then purchase the song from the merchant. After the engagement transaction, the payment engine processes the merchant transaction upon completion of the action at step 418. The payment engine can provide one or more payments to various entities associated with the engagement management system. For example, if the transaction was completed based upon a consumer visiting a publisher or merchant, the publisher can receive a portion of the transaction proceeds as well as the merchant upon completion of the action.

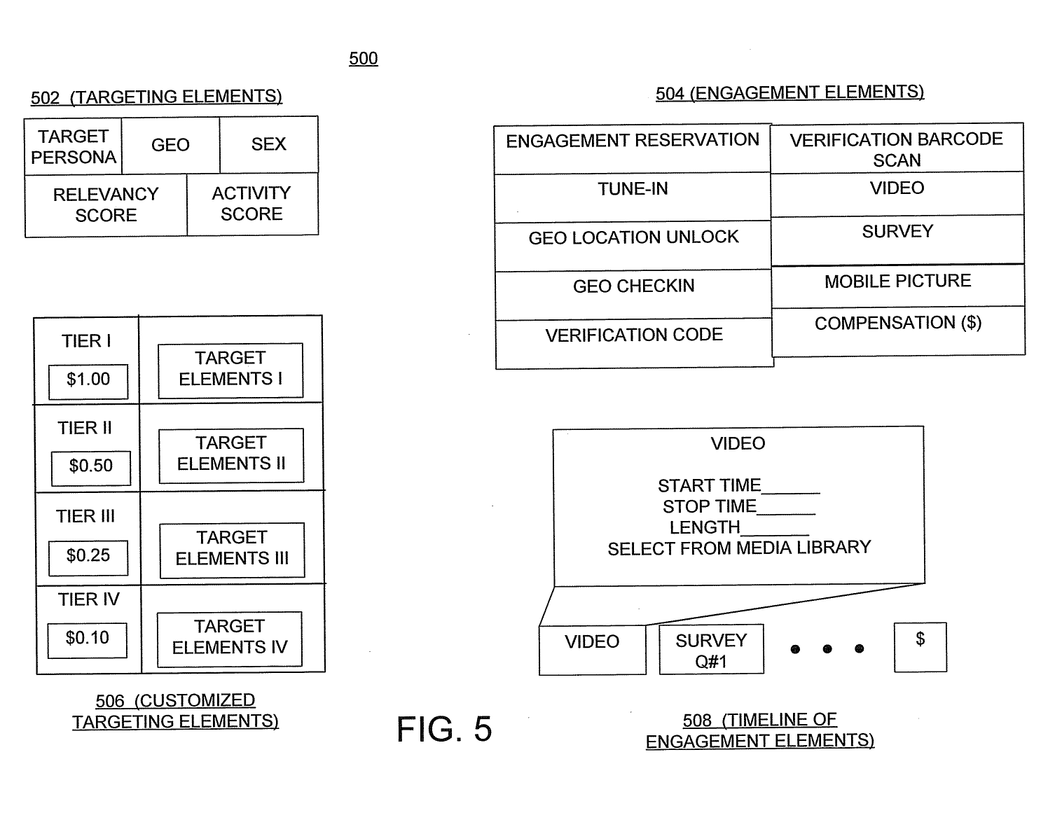

FIG. 5 is a block diagram of an interface 50 0 for creating and implementing compensation events with engagement management system 102. The interface 500 displays targeting elements 502, engagement elements 504, customized targeting elements 506 and a timeline of engagement elements 508. Targeting elements 502 present selectable elements relevant to a sponsor in a campaign. Exemplary elements include a target persona (e.g., defined by multiple attributes of a consumer profile), a geographic location, a sex of the consumer, a relevancy score and/or an activity score. Each of these targeting elements can be selected and placed within respective tiers of the customized targeting elements 506. In the example interface 500 that is shown, four tiers provide various target elements. Each tier is also associated with a particular compensation value based on the target elements desired for a particular campaign.

The engagement elements 504 are selectable within the interface 500 and can be selected and positioned within the timeline of engagement elements 508. In the example shown, the engagement elements can include an engagement reservation, a geographic location unlock, a geographic check-in, tune-in, a verification code, a verification barcode scan, a video, a survey, a mobile picture and/or compensation for the engagement. These engagement elements 504 are selected and positioned within a timeline 508. It is worth noting that the timeline need not be linear as shown, but may also include various branches depending upon survey results or activity of a consumer based on engagement during the engagement elements.

A description of various engagement elements is provided below:

Reservation: When a consumer is within a specified “trading radius” (x miles from a geo location) an engagement could be reserved. In one embodiment this reservation could be used in conjunction with a “Verified Check-in” engagement.

GEO Checkin: at GEO location—when a consumer's GPS enabled computing device is within the defined GPS footprint. In one embodiment this could be used as the only element in the “GEO checkin” (unverified) engagement that would complete the compensation event.

Tune-in: A television Tune-in element used in conjunction with or without an “Engagement Reservation” the consumer can verify the viewing of a television show by a number of means including but not limited to: audio identification, code presented on screen, etc.

GEO Unlock: Similar to the GEO check-in, only a dependent “GEO unlock” element is used as a preceding step to complete a “Verified Checkin”.

Code Verification: Used in conjunction with a GEO unlock element or on its own, a code verification is a code that can be sent to the device that the consumer is using.

Barcode Verification: 1D/2D Barcode, QR Code “Barcode Verification” Used in conjunction with a GEO unlock element or on its own, the camera on a GPS enabled smartphone can be used to take a picture/scan a barcode. Barcodes can be product UPC codes, provided by the engagement creator, or generated by the engagement management system to be unique to the consumer, geo location, or any other parameter provided by the engagement creator.

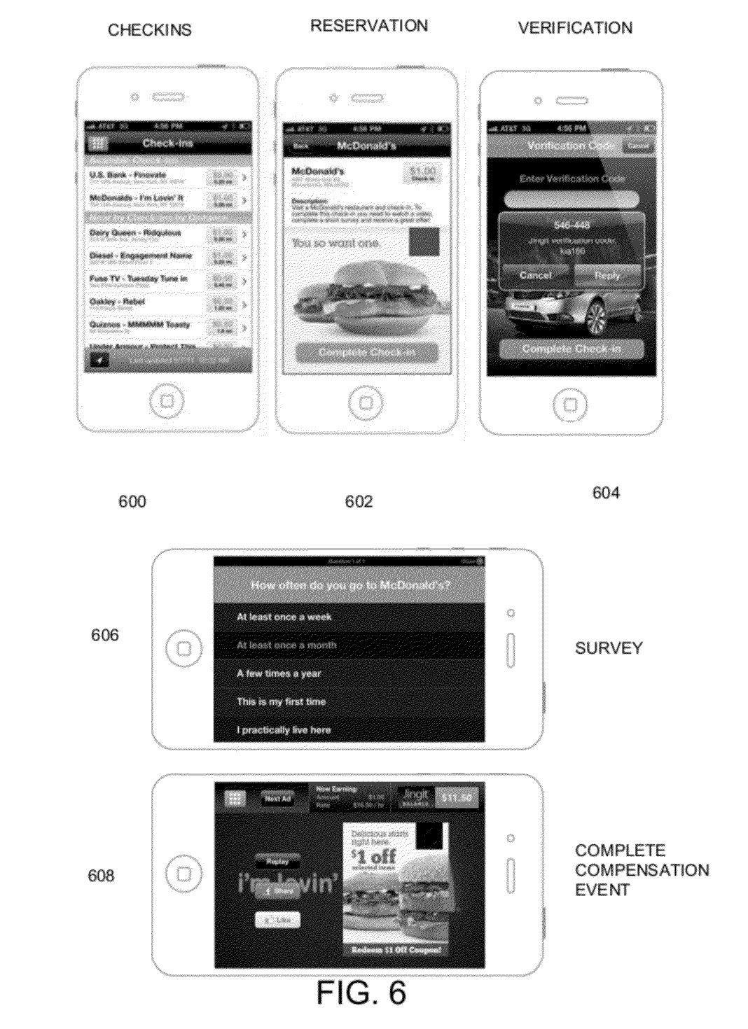

FIG. 6 provides exemplary screen shots of engagement elements 504. Screen shot 600 shows a checkins screen. The screen 600 includes available checkins (e.g., within a particular radius) and nearby checkins (e.g., close to the consumer but outside the particular radius). Screen 602 provides a reservation that a consumer can use to reserve a particular offer, such as a discount on goods. Once a consumer has reserved the offer, the reservation can be counted against a budget. Furthermore, the reservation can be subject to a particular expiration, which ultimately can be released if not utilized in a specified time frame. A verification screen 604 presents a verification code and a space to enter the verification code so that a consumer can provide the consumer with an offer, such as a test drive for a car. Screen 606 provides an exemplary survey which includes a question and multiple choice answers for the question, each answer being selectable by the consumer. Screen 608 provides a compensation screen, after the consumer has performed the event and receives compensation. The compensation screen 608 provides the consumer the ability to replay a video, share the video or view a further advertisement for compensation.

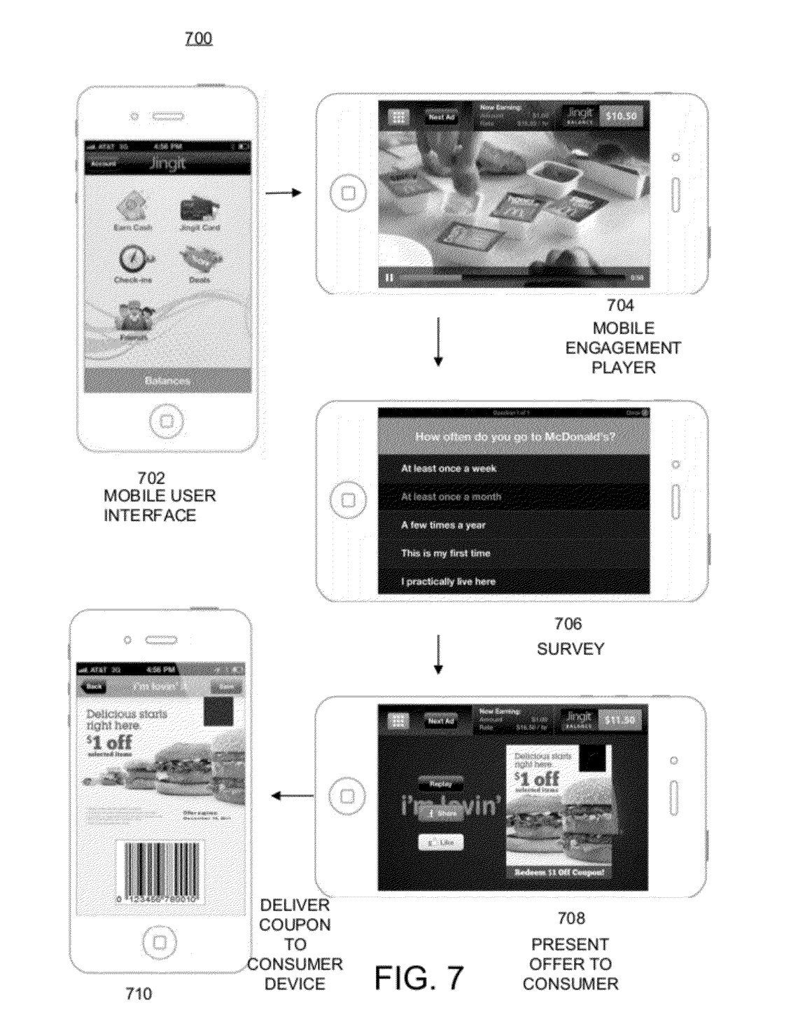

FIG. 7 provides a method 700 in which various screen shots illustrate steps for compensating a consumer and providing an offer. Step 702 provides a general mobile user interface, in which a consumer can select various options for engaging the engagement management system 102. In step 702, the consumer has selected an option to earn compensation, for example, by watching a video and completing a survey. At screen 704, a video is presented to the consumer. Next, at screen 706, the survey is presented to the consumer. At screen 708, compensation is provided to the consumer as well as an offer, which amounts to a discount of goods. At screen 710, the coupon is delivered to the consumer device, which can be used at a physical location to purchase goods based on the video and survey provided in screens 704 and 706.

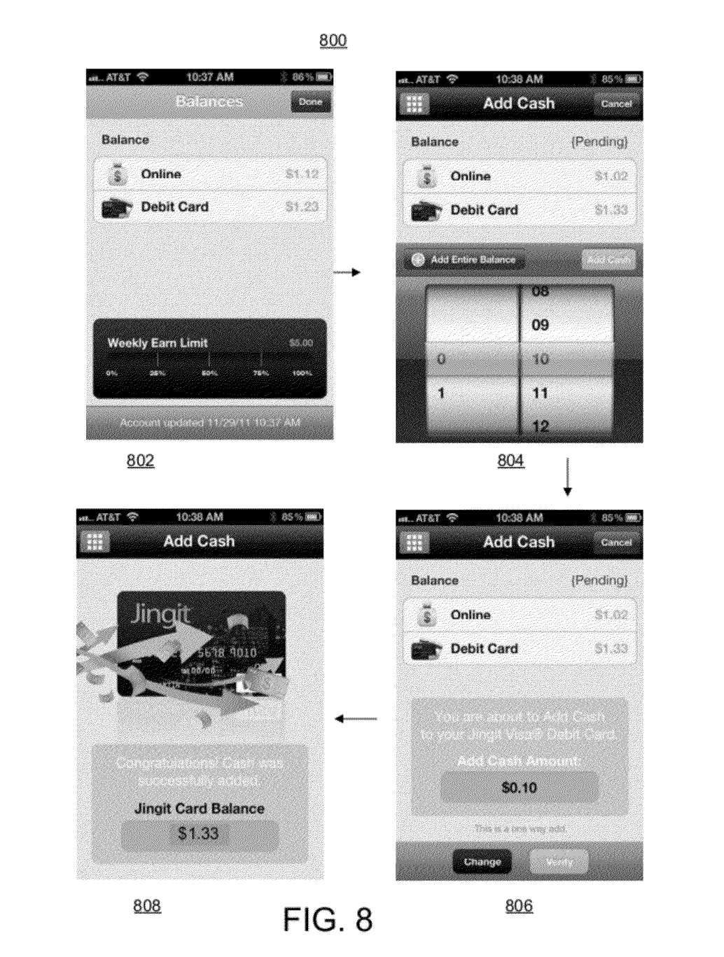

FIG. 8 is a diagram of a method 800 for transferring a balance from compensation earned with the engagement management system to a prepaid debit card in real time. Screen 802 illustrates both an online and debit card balance, wherein the consumer may choose to transfer the online balance to a debit card account. At screen 804, the consumer can select an amount of cash to transfer to the debit card. In this instance, the consumer has selected $0.10 to be transferred to the debit card account. At screen 806, a confirmation is presented to the consumer, wherein the consumer can confirm that indeed the amount selected is to be transferred to the debit card balance. At screen 808, the balance is successfully transferred to the debit card balance and a screen confirming the transfer is presented to the consumer.

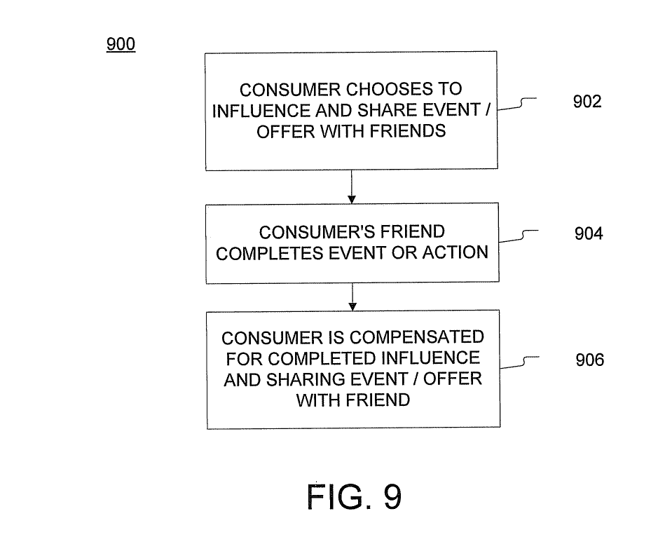

FIG. 9 is a diagram of a method 900 of an engagement between a consumer and the engagement management system. At step 902 the consumer could choose to influence and share the event or offer with friends. The consumer's friend or friends that complete the event or offer at step 904 from the sharing event in 902 can be compensated at step 906. Furthermore, the activity score 262 (i.e., sharing attributes 270) can be adjusted based on the completion of method 900.

Although the present disclosure has been described with reference to preferred embodiments, workers skilled in the art will recognize that changes can be made in form and detail without departing from the spirit and scope of the present disclosure.

What is claimed is:

1. A method, comprising:
initiating a consumer profile for a consumer, the profile including a persona and reliability score;
accessing information about the consumer;
updating the consumer profile based on the accessed information;
adjusting the reliability score based on activity of the consumer.

2. The method of claim 1, wherein the accessed information comprises information from an authenticator.

3. A method, comprising:
initiating a sponsor campaign;
identifying a budget, events and offers for a target group of the campaign;
escrowing currency with a payment engine based on the budget;
engaging consumers based on the target group;
reserving compensation for a consumer based on initiation of a compensation event; and
releasing compensation upon completion of the event.

4. The method of claim 3, wherein the compensation is released in real time.

5. The method of claim 3 and further comprising:
engaging the consumer through a publisher;
compensating the publisher and consumer in real time upon completion of the event.

6. The method of claim 3 and further comprising:
updating the currency in escrow after releasing compensation.

7. The method of claim 6 and further comprising;
completing the campaign after the currency in escrow has been depleted.

8. The method of claim 3 and further comprising:
transferring currency from a consumer account to an open loop or closed loop card in real time, the card being associated with an account for completing a transaction.

9. The method of claim 3 and further comprising:
transferring currency from a consumer account to an online payment account in real time.

10. The method of claim 3 and further comprising:
transferring currency to a consumer account upon completion of the event; and
using compensation from the event to purchase an item from a merchant in real time.

11. A method, comprising:
receiving an indication that a first consumer has shared an event and/or offer with a second consumer;
receiving an indication that the second consumer has completed a transaction associated with the event and/or offer;
compensating the first consumer upon completion of the transaction.
